(19) United States
(12) Patent Application Publication
(10) Pub. No.: US 2006/0291921 A1
(43) Pub. Date: Dec. 28, 2006

(54) Fusing unit and image forming apparatus using the same

(75) Inventors: Dong-jin Seol, Suwon-si (KR); Hwan-guem Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/373,210

(22) Filed: Mar. 13, 2006

(30) Foreign Application Priority Data
Jun. 23, 2005 (KR) 10-2005-0054383

(51) Int. Cl. G03G 15/20

(52) U.S. Cl. 399/329

(57) ABSTRACT

A fusing apparatus and an image forming apparatus using the fusing apparatus are provided. The fusing apparatus includes a fusing roller having a heat generating unit and a pressing unit having a fusing belt supported by at least two pressing members that circulates and contacts the fusing roller by the pressing members.

### CROSS-REFERENCE TO RELATED PATENT APPLICATION

This application claims the benefit under 35 U.S.C. § 119(a) of Korean Patent Application No. 10-2005-0054383, filed on Jun. 23, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus having a fusing unit using a fusing belt to fuse an image on paper.

2. Description of Related Art

Generally, an image forming apparatus is an apparatus for forming a desired image by receiving digital image signals corresponding to the desired image. An electrostatic latent image is formed on a photosensitive medium by using an exposing unit, such as a laser scanning unit (LSU). A toner image is developed from the electrostatic latent image by using a toner. The toner image is transferred to a recoding medium. The toner image is fused on the recording medium by applying heat and pressure to the toner image.

A single-pass type color image forming apparatus generally includes four photosensitive media, four exposing units forming the electrostatic latent images on the four photosensitive media, and four developing units performing development by supplying toners having black K, cyan C, magenta M, and yellow Y colors to the electrostatic latent images formed on the four photosensitive media. The four photosensitive media contact an intermediate transfer belt. The K, C, M, and Y toner images developed on the four photosensitive media are overlapped and transferred to the intermediate transfer belt to form a color toner image. The color toner image is transferred and fused onto paper, so that a color image is printed.

FIG. 1 is a longitudinal cross sectional view showing a two-roller type fusing apparatus using a fusing roller and a pressing roller.

Referring to FIG. 1, a fusing unit includes a fusing roller 10 constructed with a pipe-shaped metal pipe and a pressing roller 20 disposed to face the fusing roller 10 through a paper 30 under the fusing roller 10.

A heat generating unit 12 constructed with a halogen lamp is disposed at a center of an inner portion of the fusing roller 10. A release layer 13, preferably made of Teflon™ or the like, is formed on a surface of the fusing roller 10. The heat generating unit 12 generates heat in the inner portion of the fusing roller 10, and the fusing roller 10 receives radiation energy transmitted from the heat generating unit 12 and heated by thermal energy converted by an opto-thermal conversion layer 11 provided on an inner surface layer thereof. Due to thermal conduction of the thermal energy transmitted to the fusing roller 10, the release layer 13 is heated up to a predetermined temperature.

The pressing roller 20 includes a metal pipe 21 provided to rotate about a shaft 23, an elastic rubber layer 22 provided on a circumferential surface of the metal pipe 21, and a spring unit 24 pressing the shaft 23 toward the fusing roller 10.

A nip N, that is, a contact area in which the fusing roller 10 and the pressing roller 20 contact each other, is formed. The paper 30 passing through the nip between the fusing roller 10 and the pressing roller 20 is pressed with an elastic force by the spring unit 24.

At this time, a powder-state toner image 31 formed on the paper 30 is pressed and heated with heat and pressure applied by the pressing roller 20 and the fusing roller 10.

Namely, the toner image 31 is fused onto the paper 14 with heat and pressure by the fusing roller 10 and the pressing roller 20.

Since the conventional fusing apparatus using the halogen lamp as a heat source consumes a large amount of unnecessary electric power, there is a need to lower the temperature by blocking power when there is no printing task. When turned on for the printing task, the conventional fusing apparatus requires a relatively long warm-up time until the apparatus reaches a fusing temperature.

Since the fusing roller of the conventional fusing apparatus is heated with the radiation energy transmitted from the heat source, a heat transmission rate is slow, and because the heat is transmitted to the paper by the contact of the fusing roller to the paper, the compensation for temperature variation is slow due to a decrease in temperature, so that it is difficult to control the temperature distribution.

Recently, a printing speed of the image forming apparatus has been high, and a time of the paper passing through the fusing unit has been shortened. However, since a nip width, that is, a contact area between the fusing roller and the pressing roller is narrow, there is a limitation in forming an image at a high speed. Therefore, the nip must be enlarged to shorten the time in which the paper passes through the fusing unit and to facilitate high speed printing.

As a method of enlarging the nip, there are a method of increasing a diameter of the fusing roller or the pressing roller, a method of increasing a thickness of a release layer or an elastic rubber layer formed on an outmost circumferential surface of each roller, and a method of increasing a nip pressing force.

In the first method, there is a shortcoming in that, because the diameters of the rollers increases, the whole volume increases and warm-up is slow.

In the second method, warm-up is slow, and a temperature of the fusing roller needs to be raised to maintain the temperature of the outermost layer, such as the release layer and the elastic rubber layer, at a fusing temperature. Therefore, there is a problem of high-temperature deterioration and durability deterioration of an adhesive portion, the release layer, or the elastic rubber layer.

In the third method, although a fusing characteristic can be ensured by improving a pressing characteristic of the pressing roller, if the pressure to the nip increases, durability may deteriorate due to severe deformation of the release layer or the elastic rubber layer, and a jam may easily occur due to deterioration in a paper feeding characteristic. The apparatus may also be overstrained due to an increase in a driving torque.

Accordingly, a need exists for an image forming apparatus having an improved fusing unit that increases the size of the nip area between a fusing roller and a pressing unit.

### SUMMARY OF THE INVENTION

The present invention provides a fusing apparatus having a pressing unit using a fusing belt to increase a nip area between a fusing roller and the pressing unit and an image forming apparatus using the fusing apparatus.

According to an aspect of the present invention, a fusing apparatus includes a fusing roller having a heat generating unit. A pressing unit has a fusing belt supported by at least two pressing members to circulate and contact the fusing roller by the pressing members.

In the aforementioned aspect of the present invention, the pressing member may include a pressing roller having a predetermined diameter. A supporting member supports one portion of the circulating fusing belt and has an elastic member at a side contacting the fusing belt.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is an elevational view in cross section of a conventional two-roller type fusing apparatus using a fusing roller and a pressing roller;

FIG. 2 is a schematical diagram of a single-pass type color image forming apparatus using a fusing apparatus according to an exemplary embodiment of the present invention;

FIG. 3 is an elevational view in cross section of a fusing apparatus according to an exemplary embodiment of the present invention shown in FIG. 2;

FIG. 4 is an enlarged elevational view of a supporting member shown in FIG. 3; and

FIG. 5 is an elevational view in cross section of a fusing apparatus according to a second exemplary embodiment of the present invention.

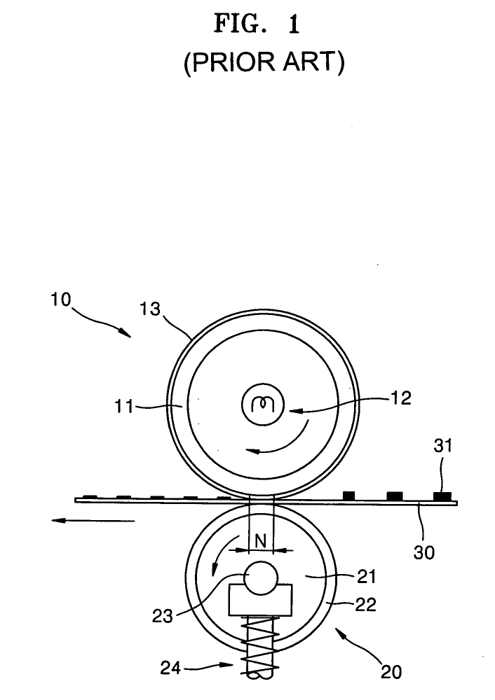

Throughout the drawings, like reference numerals will be understood to refer to like parts, components and structures.

### DETAILED DESCRIPTION OF THE INVENTION

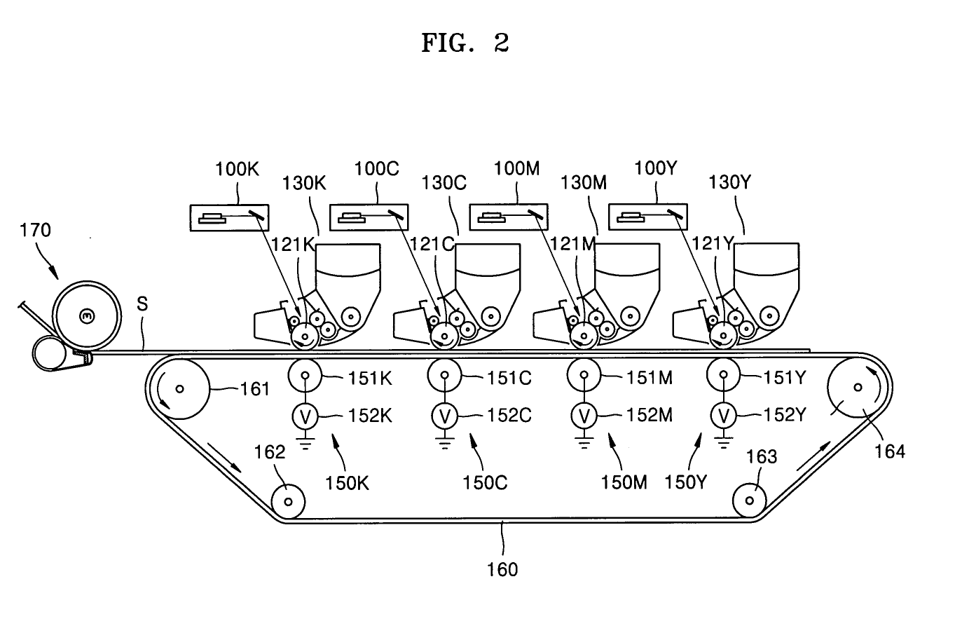

Referring to FIG. 2, a color image forming apparatus includes four exposing units 100K, 100C, 100M, and 100Y, four developing units 130K, 130C, 130M, and 130Y having respective photosensitive media 121K, 121C, 121M, and 121Y, four transfer units 150K, 150C, 150M, and 150Y, a feeding belt 160, and a fusing apparatus 170.

The exposing units 100K, 100C, 100M, and 100Y form electrostatic latent images by irradiating light of black K, cyan C, magenta M, and yellow Y colors corresponding to image information on the photosensitive media 121.

The developing units 130K, 130C, 130M, and 130Y perform development by supplying toners having black K, cyan C, magenta M, and yellow Y colors to the electrostatic latent images on the photosensitive media 121.

The feeding belt 160 faces the photosensitive media 121K, 121C, 121M, and 121Y and feeds a paper S. The photosensitive media 121K, 121C, 121M, and 121Y contact a paper S or the feeding belt 160. The paper S is adsorbed to the feeding belt 160 with an electrostatic force.

The transfer units 150K, 150C, 150M, and 150Y include transfer rollers 151K, 151C, 151M, and 151Y facing the photosensitive media 121K, 121C, 121M, and 121Y and voltage applying members 152K, 152C, 152M, and 152Y applying voltages to the transfer rollers 151K, 151C, 151M, and 151Y.

When the voltage applying members 152K, 152C, 152M, and 152Y apply transfer voltages having polarities opposite to the toner images to the transfer rollers 151K, 151C, 151M, and 151Y, transfer electric fields are applied to a rear surface of the feeding belt 160. K, C, M, and Y color toner images formed on the photosensitive media 121K, 121C, 121M, and 121Y are overlapped and transferred to a paper S, so that a color toner image is formed on a paper S.

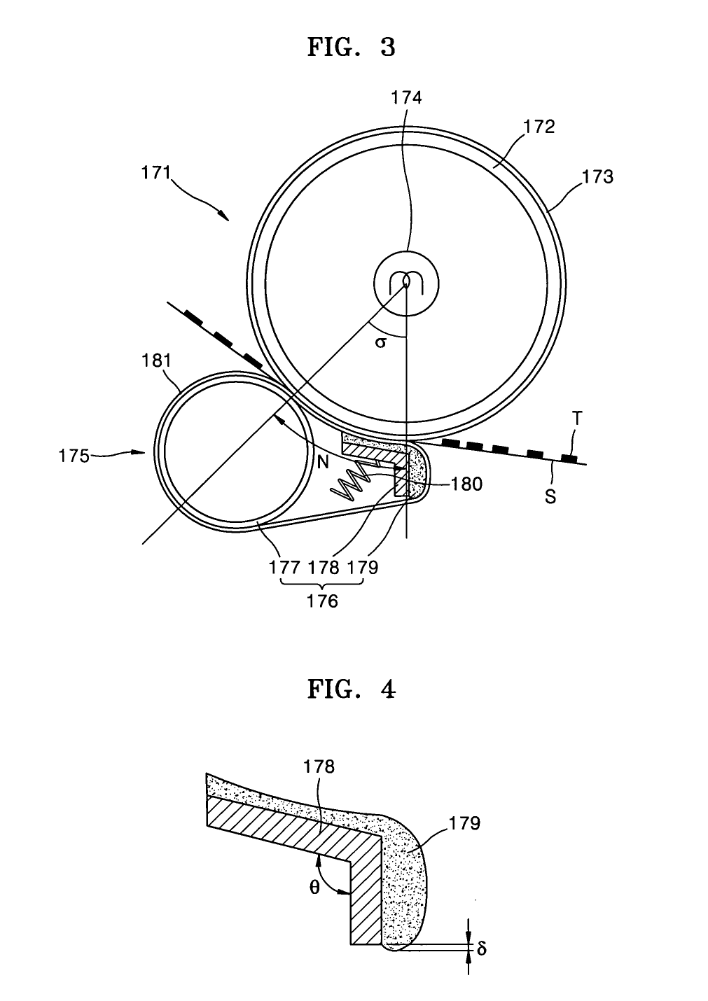

As shown in FIG. 3, the fusing unit 170 fuses the color toner image on the paper by applying heat and pressure and includes a fusing roller 171 and a pressing unit 175.

The fusing roller 171 applies heat to the color toner image and includes a pipe-shaped cylindrical metal core pipe 172 and a heat generating unit 174 generating heat by using current transmitted from an external power supply (not shown) provided to an inner side of the metal core pipe 172. A release layer 173 made of an elastic material to improve releasability of the toner image is provided on a circumferential surface of the metal core pipe 172.

Radiation energy (heat) generated by the heat generating unit 174 is transmitted to the metal core pipe 172 through air charged in an inner portion of the metal core pipe 172 and converted to thermal energy by an opto-thermal conversion layer (not shown) coated on an inner side surface of the metal core pipe 172 to heat the fusing roller 174. The release layer 173 is then heated to a predetermined fusing temperature by thermal conduction.

The pressing unit 175 presses the paper S on which the toner image T is transferred toward the fusing roller 171 with a predetermined pressure and includes a pressing member 176 and a fusing belt 181.

The pressing member 176 supports an inner portion of the circulating fusing belt 181 and includes a pressing roller 177 and a supporting member 178.

The pressing roller 177 preferably has a cylindrical shape with a predetermined diameter and supports one portion of the fusing belt 181 and presses the fusing belt 181 to contact the fusing roller 171.

The supporting member 178 supports the other portion of the fusing belt 181 and presses the fusing belt 181 to contact the fusing roller 171. Additionally, the supporting member 178 is curved with a predetermined angle so that the fusing belt 181 may circulate thereon. The supporting member 178 is provided with an elastic member 179 at a side contacting the fusing belt 181. The elastic member 179 may be adhered to the supporting member 178 by using an adhesive. A release layer is provided on the elastic member 179 to improve releasability with the fusing belt 181.

As shown in FIG. 4, the supporting member 178 is preferably curved with an angle of approximately 90°≦θ≦180°. The elastic member 179 is provided to the supporting member 178 with a predetermined thickness, and because the elastic member 179 is made of an elastic material, the elastic member 179 may elastically contact the fusing belt 181 with the fusing roller 171.

The elastic member 179 is preferably disposed to further extend past an end of the supporting member 178 by a length δ, so that the supporting member 178 cannot directly contact the fusing belt 181. Therefore, abrasion of the fusing belt 181 may be substantially prevented.

The elastic member 179 is preferably formed to extend by the length δ at a bent portion to facilitate rotation of the fusing belt 181.

Preferably, the elastic member 179 is formed with a shape substantially corresponding to a shape of the fusing roller 171, thereby substantially maintaining a pressing force between the fusing belt 181 and the fusing roller 171.

The pressing roller 177 and the supporting member 178 are separated from each other by a predetermined interval. A nip angle σ is formed between portions thereof contacting the fusing roller 171. A size of an nip N formed by contacting the fusing belt 181 and the fusing roller 171 by the pressing roller 177 and the supporting member 178 is determined according to the nip angle σ.

When the nip angle σ is shorted, the nip N decreases. When the nip angle σ is enlarged, the nip N increases. Therefore, it is preferable that the pressing roller 177 and the supporting member 178 be disposed to an inner portion of the fusing belt 181 to support the fusing belt 181 to circulate and to maximize the size of the nip N where the fusing belt 181 contacts the fusing roller 171.

An elastic arm 180, such as a spring, exerts an elastic force on both ends of the supporting member 178 toward the fusing roller 171. By elastically biasing the supporting member 178 toward the fusing roller 171, the elastic arm 180 may closely contact the fusing belt 181 with the fusing roller 171, thereby maintaining tension of the fusing belt 181.

When the tension of the fusing belt 181 is small, the fusing belt 181 cannot properly circulate and closely contact the fusing roller 171. Therefore, the tension is maintained by using the elastic arm 180 to press the supporting member 178 toward the fusing roller 171.

The fusing belt 181 may be constructed by forming a base layer, or a release layer on a base layer, or by forming an elastic layer on a base layer and a release layer on the elastic layer. The base layer may be made of a polymer material, such as polyimide (PI), or a metal material, such as nickel (Ni), a Ni alloy, stainless steel, aluminum (Al), an Al alloy, copper (Cu), and a Cu alloy.

The elastic member 179 may be made of a Si rubber, urethane, a foaming resin, and the like. The release layer may be made of a fluoride resin.

The pressing roller 177 may be driven with a separate driving power, and the fusing belt 181 may also be circulated by the separate driving power. The fusing belt 181 may be passively circulated by contacting the fusing roller 171.

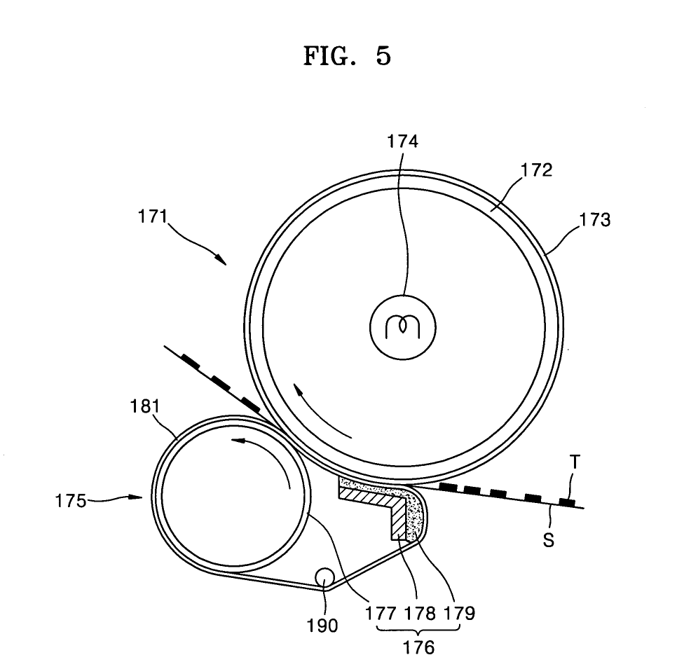

Referring to FIG. 5, a construction of a fusing apparatus according to a second exemplary embodiment of the present invention is substantially similar to the fusing apparatus according to the exemplary embodiment shown in FIG. 3 except for a tension adjustment roller 190. Therefore, like members having like functions are denoted by like reference numerals, and description thereof is omitted.

The tension adjustment roller 190 is disposed to an inner portion of the fusing belt 181 to support the fusing belt 181 to circulate with a substantially constant tension maintained.

In addition to the tension adjustment roller 190, as shown in FIG. 3, the elastic arm 180 may be disposed to substantially maintain the tension of the fusing belt 181.

Although examples where the fusing apparatus 170 according to exemplary embodiments of the present invention are applied to the single-pass type color image forming apparatus are described above, the image forming apparatus is not limited to the single pass type, but the fusing apparatus 170 may be applied to all the electrophotography scheme image forming apparatuses.

According to a fusing apparatus of exemplary embodiments of the present invention, the following effects may be obtained.

Firstly, a nip width is enlarged by using a fusing belt, so that it is possible to increase a nip staying time of a paper on which a toner image is transferred corresponding to a printing speed.

Secondly, a nip pressing force may be reduced, so that it is possible to prolong lifetime of parts.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A fusing apparatus, comprising:
a fusing roller having a heat generating unit; and
a pressing unit having a fusing belt supported by at least two pressing members around which the fusing belt circulates and that contact the fusing belt with the fusing roller.

2. The fusing apparatus of claim 1, wherein the at lest two pressing members include
a pressing roller having a predetermined diameter; and
a supporting member supporting one portion of the fusing belt to circulate and an elastic member connected to the supporting member at a side contacting the fusing belt.

3. The fusing apparatus of claim 2, wherein
the supporting member is curved with an angle ranging from approximately 90 degrees to approximately 180 degrees.

4. The fusing apparatus of claim 2, wherein
the elastic member extends past an end of the supporting member so that the supporting member does not contact the fusing belt.

5. The fusing apparatus of claim 2, wherein
an elastic arm exerts an elastic force on the supporting member toward the fusing belt.

6. The fusing apparatus of claim 5, wherein
the elastic arm is a spring.

7. The fusing apparatus of claim 2, wherein
the pressing roller is a driven roller.

8. The fusing apparatus of claim 1, wherein
a tensor adjustment roller supports the fusing belt to circulate and adjusts tension of the fusing belt.

9. The fusing apparatus of claim 2, wherein
the elastic member is secured to the supporting member by an adhesive.

10. The fusing apparatus of claim 2, wherein
the elastic member is made from a material selected from the group consisting of Si rubber, urethane, and a foaming resin.

11. An image forming apparatus, comprising:
a plurality of developing units, each developing unit having a photosensitive medium on which a different color toner image is formed;
a feeding belt facing the plurality of the photosensitive medium to circulate and supporting a paper on which the different color toner images are to be transferred;
a fusing unit fusing the toner images onto the paper, wherein the fusing unit includes
a fusing roller having a heat generating unit; and
a pressing unit having at least two pressing members to support and circulate a fusing belt and to contact the fusing belt with the fusing roller.

12. The image forming apparatus of claim 11, wherein the pressing member includes
a pressing roller having a predetermined diameter; and
a supporting member supporting one portion of the fusing belt to circulate and an elastic member connected to the supporting member at a side contacting the fusing belt.

13. The image forming apparatus of claim 12, wherein
the supporting member is curved with an angle ranging from approximately 90 degrees to approximately 180 degrees.

14. The image forming apparatus of claim 12, wherein
the elastic member extends past an end of the supporting member so that the supporting member does not contact the fusing belt.

15. The image forming apparatus of claim 12, wherein
the elastic arm exerts an elastic force on the supporting member toward the fusing belt.

16. The fusing apparatus of claim 15, wherein
the elastic arm is a spring.

17. The image forming apparatus of claim 12, wherein
the pressing roller is a driven roller.

18. The image forming apparatus of claim 12, wherein
a tensor adjustment roller supports the fusing belt to circulate and adjusts tension of the fusing belt.

19. The fusing apparatus of claim 12, wherein
the elastic member is secured to the supporting member by an adhesive.

20. The fusing apparatus of claim 12, wherein
a contact area between the fusing belt and the fusing roller forms a nip, the length of the nip being controlled by the position of the pressing roller and the elastic member inside of the fusing belt.
